(19) United States
(12) Patent Application Publication
(10) Pub. No.: US 2026/0255153 A1
(43) Pub. Date: Aug. 27, 2026

(54) Methods And Apparatus For Processing Ue Capability Information In Mobile Communications

(71) Applicant: MediaTek Inc., Hsinchu City (TW)

(72) Inventors: Jen-Chien Liu, Hsinchu City (TW); Tsung-Ming Lee, Hsinchu City (TW); Tsung-Liang Lu, Hsinchu City (TW); Mu-Tai Lin, Hsinchu City (TW); Chun-Fan Tsai, Hsinchu City (TW); Yang-Yi Zeng, Hsinchu City (TW); Yi-Chun Chu, Hsinchu City (TW); Hung-Yuan Yang, Hsinchu City (TW)

(73) Assignee: MediaTek Inc., Hsinchu City (TW)

(21) Appl. No.: 19/530,413

(22) Filed: Feb. 5, 2026

Related U.S. Application Data
(60) Provisional application No. 63/762,684, filed on Feb. 25, 2025.

(51) Int. Cl. H04W 8/22; H04W 76/20; H04W 76/30

(52) U.S. Cl. CPC H04W 8/22; H04W 76/20; H04W 76/30

(57) ABSTRACT

Various solutions for processing UE capability information in mobile communications are described. The user equipment (UE) may receive a first UE capability enquiry message from a network node. The UE may determine a maximum size for a UE capability information message. Also, the UE may compile a first UE capability information message having a message size less than or equal to the maximum size for the UE capability information message. Further, the UE may transmit the first UE capability information message to the network node to respond to the first UE capability enquiry from the network node. Based on the maximum size, the size of the UE capability information message can be well managed, and abnormal network behavior can be prevented.

### CROSS REFERENCE TO RELATED PATENT APPLICATION(S)

The present disclosure is part of a non-provisional application claiming the priority benefit of U.S. patent application Ser. No. 63/762,684, filed 25 Feb. 2025, the content of which herein being incorporated by reference in its entirety.

### TECHNICAL FIELD

The present disclosure is generally related to mobile communications and, more particularly, to processing UE capability information in mobile communications.

### BACKGROUND

Unless otherwise indicated herein, approaches described in this section are not prior art to the claims listed below and are not admitted as prior art by inclusion in this section.

In mobile communication, the user equipment (UE) capability transfer procedure is a process that allows the network to obtain information about the capabilities of a UE. With the new evolution of 3rd Generation Partnership Project (3GPP) releases, the size of UE capability information messages expands due to the introduction of new features and the increase in supported bands and aggregated carriers.

In New Radio (NR) systems, an Access and Mobility Management Function (AMF) typically stores the UE capability information uploaded by the gNodeB (gNB), enabling the network to avoid repeatedly querying the UE for its capabilities during each connection establishment. However, several problems exist with current implementations.

Network nodes may not reserve sufficient memory to store large UE capability information messages. When the size of the UE capability information exceeds the reserved memory, the network may be unable to store the information properly, leading to abnormal behaviors such as requiring the UE to report its capabilities for every connection or after every handover, or unexpectedly releasing the RRC connection.

A fundamental problem is that UEs currently have no knowledge of the memory limitations that the network may have for storing UE capability information. Without this information, UEs may send capability information messages that are too large for the network to handle, resulting in repeated connection failures. Furthermore, when the network releases a radio resource control (RRC) connection due to unacceptable UE capability information (either in terms of size or content), the UE is not informed of the specific reason for the release. Consequently, the UE may repeatedly attempt to establish connections with the same capability information, only to have the network continuously reject the connection, leading to service degradation and poor user experience.

Accordingly, a more efficient method for processing UE capability information is needed.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to processing UE capability information in mobile communications.

In one aspect, a method may involve an apparatus receiving a first user equipment (UE) capability enquiry message from a network node. The method may further involve the apparatus determining whether a downlink message comprising a maximum size for a UE capability information message is received from the network node. The method may further involve the apparatus determining a message size indicated by the downlink message as the maximum size for the UE capability information message in an event that the downlink message is received or a predefined message size as the maximum size for the UE capability information message in an event that the downlink message is not received. The method may further involve the apparatus compiling a first user equipment (UE) capability information message having a message size less than or equal to the maximum size for the UE capability information message. The method may further involve the apparatus transmitting the first UE capability information message to the network node to respond to the first UE capability enquiry from the network node.

In another aspect, an apparatus may comprise a transceiver which, during operation, wirelessly communicates with a network node of a wireless network. The apparatus may also comprise a processor communicatively coupled to the transceiver. The processor, during operation, may perform operations comprising receiving a first user equipment (UE) capability enquiry message from a network node. The processor, during operation, may also perform operations comprising determining whether a downlink message comprising a maximum size for a UE capability information message is received from the network node. The processor, during operation, may also perform operations comprising determining a message size indicated by the downlink message as the maximum size for the UE capability information message in an event that the downlink message is received or a predefined message size as the maximum size for the UE capability information message in an event that the downlink message is not received. The processor, during operation, may also perform operations comprising compiling a first UE capability information message having a message size less than or equal to the maximum size for the UE capability information message. The processor, during operation, may further perform operations comprising transmitting, via the transceiver, the first UE capability information message to the network node to respond to the first UE capability enquiry from the network node.

In yet another aspect, a method may involve a network node transmitting a first user equipment (UE) capability enquiry message to an apparatus. The method may further involve the network node determining whether to transmit to the apparatus a downlink message comprising a maximum size for a UE capability information message. The maximum size for the UE capability information message is used to limit a message size of a UE capability information message. The method may further involve the network node receiving a first UE capability information message having a message size less than or equal to the maximum size from the apparatus for responding to the first UE capability enquiry message in an event that the downlink message comprising the maximum size for the UE capability information message is transmitted.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting example scenarios of information elements for indicating maximum size for UE capability information messages under schemes in accordance with implementations of the present disclosure.

FIG. 3 is a diagram depicting an example scenario of RRC release message structure under schemes in accordance with implementations of the present disclosure.

FIG. 4A is a diagram depicting an example message flow scenario under a scheme of indicating the maximum size for UE capability information by system information block in accordance with implementations of the present disclosure.

FIG. 4B is a diagram depicting an example message flow scenario under a scheme of indicating the maximum size for UE capability information by a radio resource control (RRC) message in accordance with implementations of the present disclosure.

FIG. 5 is a flowchart of an example process for UE-side handling of UE capability information in accordance with an implementation of the present disclosure.

FIG. 6 is a flowchart of an example process for network-side handling of UE capability information in accordance with an implementation of the present disclosure.

FIG. 7 is a flowchart of an example process for UE-side response to RRC release in accordance with an implementation of the present disclosure.

FIG. 8 is a block diagram of an example communication system in accordance with an implementation of the present disclosure.

FIG. 9 is a flowchart of an example process in accordance with an implementation of the present disclosure.

FIG. 10 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to processing UE capability information in mobile communications. According to the present disclosure, a number of possible solutions may be implemented separately or jointly. That is, although these possible solutions may be described below separately, two or more of these possible solutions may be implemented in one combination or another.

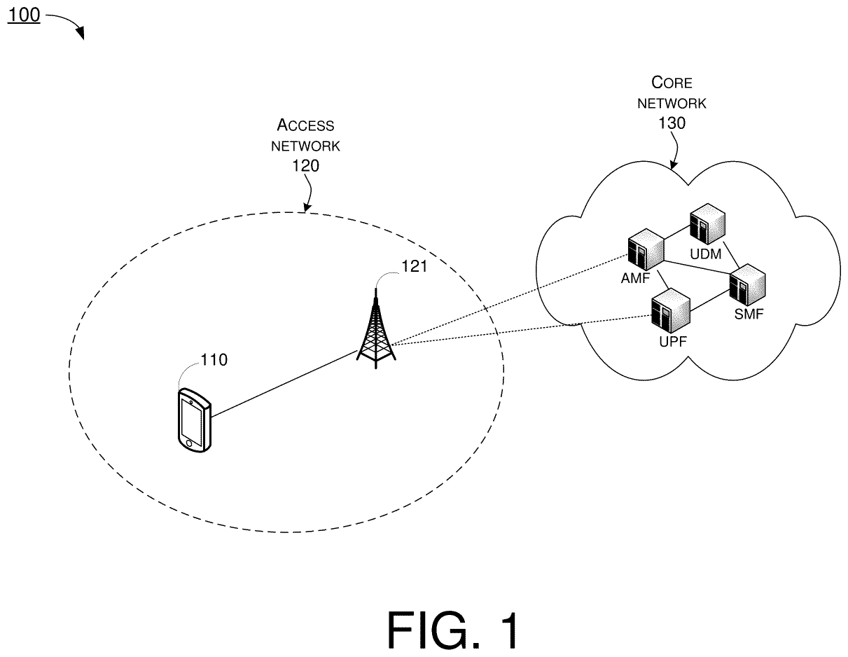

FIG. 1 illustrates an example scenario 100 of a communication environment in which various solutions and schemes in accordance with the present disclosure may be implemented. Scenario 100 involves a UE 110 in wireless communication with a wireless communication network (e.g., an LTE network, a 5G/NR network, an IoT network, or a 6G network) consisting of an access network 120 and a core network 130. The UE 110 may be a smart phone, a wearable device, an IoT device, and a tablet, etc. Alternatively, the UE 110 may be a notebook (NB) or personal computer (PC) inserted or installed with a data card which includes a modem and radio frequency (RF) transceiver(s) to provide the functionality of wireless communication. In one embodiment, the access network 120 is connected to the core network 130 by means of the NG interface, more specifically to a user plane function (UPF) by means of the NG user-plane part (NG-u), and to an access and mobility management function (AMF) by means of the NG control-plane part (NG-c). The access network 120 may include a base station (BS) 121, which may be connected to multiple UPFs/AMFs for the purpose of load sharing and redundancy. In addition, the core network may include other entities, such as a session management function (SMF) and a unified data management (UDM), etc. In some embodiments, the access network 120 may include multiple BSs, each of which may provide communication coverage for a geographic coverage area where communications with the UE 110 are supported.

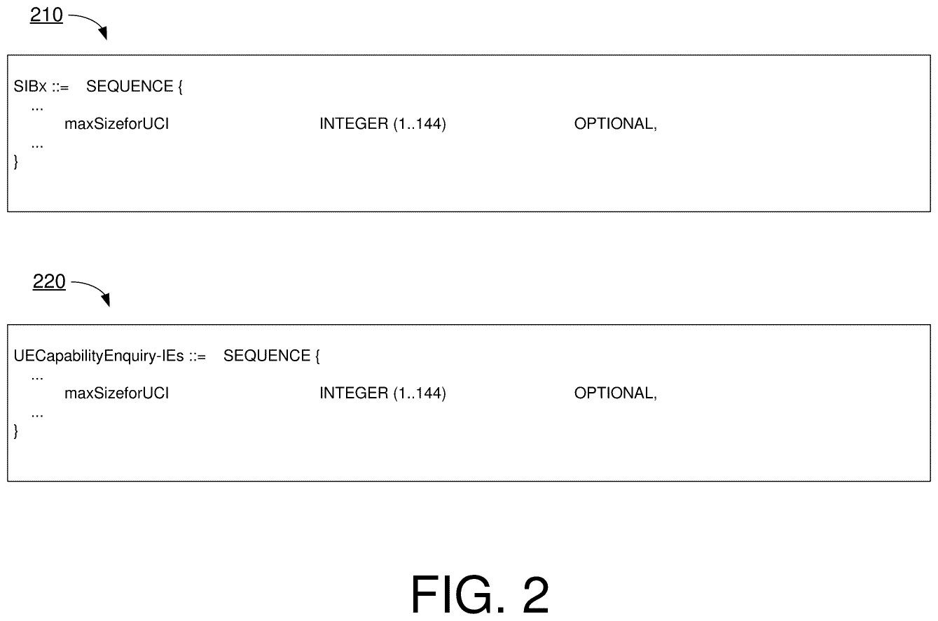

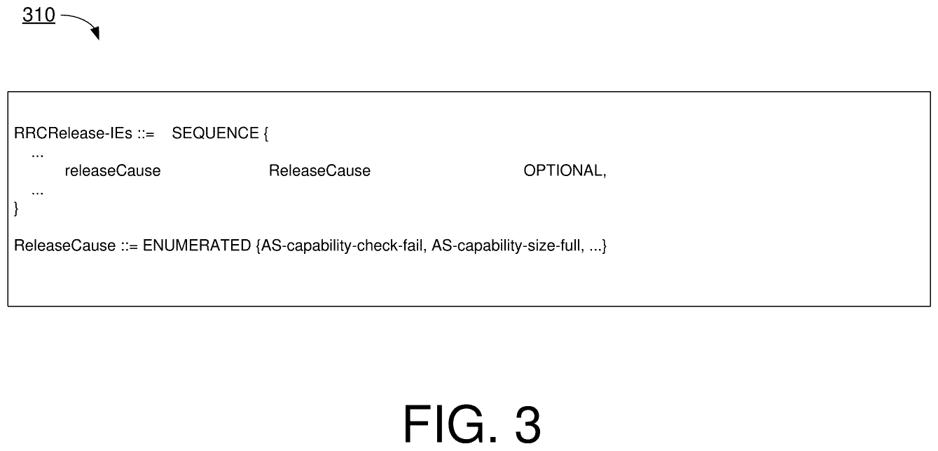

In scenario 100, a scheme to processing UE capability information within the wireless communication network is provided. The network (e.g., BS 121) may provide a maximum size for storing/handling the UE capability information message to the UE 110 to prevent the UE from sending capability information that exceeds the network's memory/capability limitations. A downlink message for conveying the maximum size to the UE is illustrated in FIG. 2. Additionally, when the network releases an RRC connection due to unacceptable UE capability information, the network can indicate specific release causes to inform the UE 110 of the reason for the connection release. An RRC message for conveying the release cause to UE is illustrated in FIG. 3. This allows the UE 110 to take appropriate actions, such as reducing the size of the capability information message or modifying the content of the capability information to comply with network requirements.

FIG. 2 is a diagram depicting example scenarios 210 and 220 of information elements that may be used to indicate the maximum size for UE capability information messages in accordance with implementations of the present disclosure. In scenario 210, a system information block (SIB) message (e.g., SIBx) may include a field maxSizeforUCI that specifies the maximum size for the UE capability information message. The field maxSizeforUCI may be defined as an optional INTEGER value ranging from 1 to 144, where the actual value in bytes equals the field value multiplied by 1000. For example, if maxSizeforUCI is set to 9, the maximum size for the UE capability information message is 9000 bytes. If maxSizeforUCI is set to 144, the maximum size is 144000 bytes. By broadcasting this information in the SIB message, the network can inform all UEs in the coverage area of the memory limitation for storing UE capability information.

In scenario 220, a UE capability enquiry message (e.g., UECapabilityEnquiry-IEs) may include the field maxSizeforUCI as an optional parameter. This allows the network (e.g., BS 121) to provide UE-specific maximum size limitations through dedicated signaling. Similar to scenario 210, the field maxSizeforUCI is defined as an optional INTEGER value ranging from 1 to 144, with the actual value in bytes calculated as the field value multiplied by 1000. When the network sends a UECapabilityEnquiry message to a specific UE (e.g., UE 110), it can include the maxSizeforUCI field to indicate the maximum acceptable size for the UE capability information message from that particular UE. This approach provides flexibility for the network to set different size limitations for different UEs based on their individual characteristics or network conditions.

FIG. 3 is a diagram depicting an example scenario 310 of an RRC release message structure in accordance with implementations of the present disclosure. Scenario 310 illustrates the information elements included in an RRCRelease-IEs message that allow the network to indicate specific reasons for releasing an RRC connection. The RRCRelease-IEs message includes a releaseCause field defined as an optional ReleaseCause parameter. The ReleaseCause is defined as an ENUMERATED type that includes specific values to indicate different reasons for connection release related to UE capability information.

Two new release cause values are introduced: AS-capability-check-fail and AS-capability-size-full. The AS-capability-check-fail value indicates that the network does not accept the content of the UE capability information message, such as when the UE reports capabilities that are incompatible with the network's requirements or when the network cannot recognize or properly handle certain capability information elements introduced in newer releases.

The AS-capability-size-full value indicates that the RRC connection is being released because the size of the UE capability information message exceeds the maximum size that the network (e.g., BS 121 or AMF) can store/handle. By providing these specific release causes, the network enables the UE to understand why the connection was released and take appropriate corrective actions. For example, upon receiving a release cause of AS-capability-check-fail, the UE may disable certain capability information elements or fallback to lower capability values for the next UE capability enquiry after the next connection is established. Upon receiving a release cause of AS-capability-size-full, the UE may reduce the size of the capability information message by removing less critical information for the next UE capability enquiry with a smaller capability report after the next connection is established.

In the proposed solution, “AS-capability-check-fail” and “AS-capability-size-full” are presented as illustrative examples of enumerated values that can be used to indicate specific release causes in the RRCRelease message, and it should be understood that these particular naming conventions are not mandatory but rather represent the underlying concepts that could alternatively be implemented using different constants, variables, or enumerated identifiers with different naming schemes while maintaining the same functional purpose of distinguishing between capability content rejection and capability size limitation scenarios. The actual implementation may employ alternative naming conventions, numerical codes, or other identifiers that convey the same semantic meaning, as the core inventive concept lies in the network's ability to explicitly indicate to the UE whether the connection release was caused by unacceptable capability content or by the capability information size exceeding the network's storage limitations, rather than in the specific textual representation of these cause values.

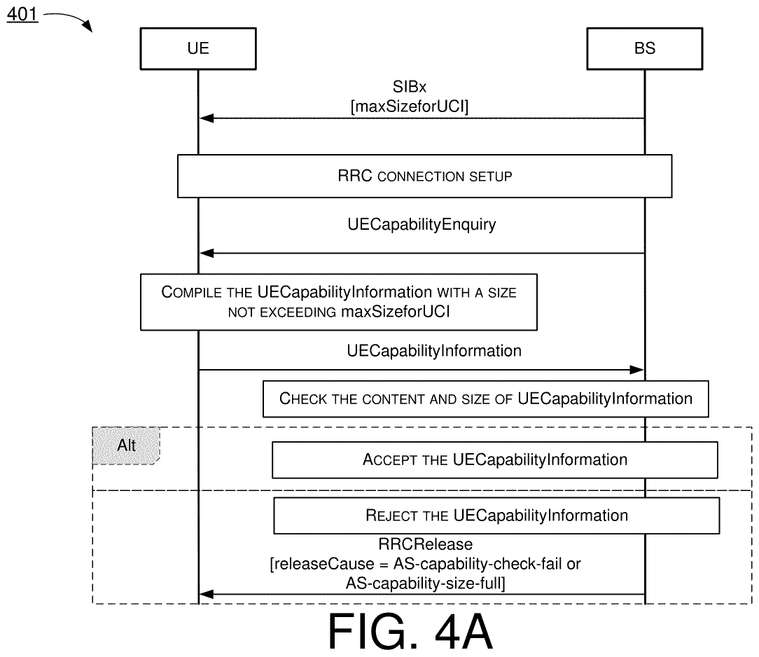

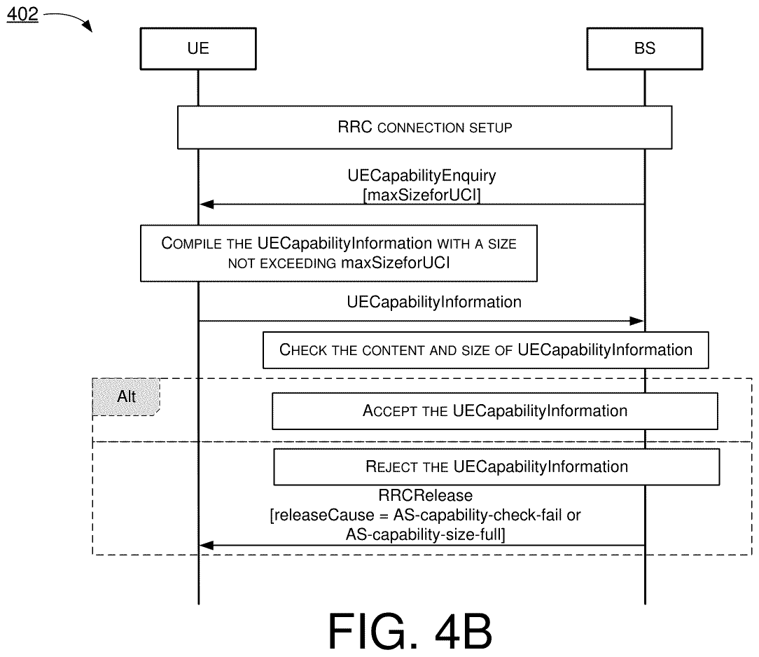

FIG. 4A is a diagram depicting an example scenario 401 of a message flow under a scheme of indicating the maximum size for UE capability information by system information block (e.g., SIBx) in accordance with implementations of the present disclosure. Scenario 401 illustrates the overall procedure for processing UE capability information between a UE and a BS, such as UE 110 and BS 121. The procedure begins with an optional step where the BS may broadcast a system information block (SIB) message (e.g., SIBx) containing the maximum size for UE capability information (maxSizeforUCI). This allows the BS (e.g., BS 121) to inform all UEs in the coverage area of the memory limitation for storing UE capability information. After the RRC connection setup procedure is completed, the BS sends a UECapabilityEnquiry message to the UE (e.g., UE 110), which does not include the maxSizeforUCI field. Upon receiving the UECapabilityEnquiry message, the UE compiles a UECapabilityInformation message with a size that does not exceed the maxSizeforUCI value. The UE then transmits the UE capability information message UECapabilityInformation to the BS. Upon receiving the UECapabilityInformation message, the BS checks both the content and size of the message. If the content and size are acceptable, the BS accepts the UECapabilityInformation and proceeds with normal operations. Alternatively, if either the content or size is not acceptable, the BS rejects the UECapabilityInformation and sends an RRCRelease message with a releaseCause field set to either AS-capability-check-fail (if the content is unacceptable) or AS-capability-size-full (if the size exceeds the network's memory limitation represented by the field maxSizeforUCI). This message flow ensures that the UE is informed of any capability-related issues and can take appropriate corrective actions.

FIG. 4B is a diagram depicting an example scenario 402 of a message flow under a scheme of indicating the maximum size for UE capability information by a dedicated radio resource control (RRC) message in accordance with implementations of the present disclosure. Scenario 402 illustrates the overall procedure for processing UE capability information between a UE and a BS, such as UE 110 and BS 121. Scenario 402 is distinct from scenario 401 in that the BS does not broadcast a system information block (SIB) message (e.g., SIBx) containing the maximum size for UE capability information (maxSizeforUCI). After the RRC connection setup procedure is completed, the BS sends to the UE (e.g., UE 110) a UECapabilityEnquiry message with the maxSizeforUCI field that contains the maximum size for UE capability information (maxSizeforUCI). Upon receiving the UECapabilityEnquiry message, the UE compiles a UECapabilityInformation message with a size that does not exceed the maxSizeforUCI value. The UE then transmits the UE capability information message UECapabilityInformation to the BS. Upon receiving the UECapabilityInformation message, the BS checks both the content and size of the message. If the content and size are acceptable, the BS accepts the UECapabilityInformation and proceeds with normal operations. Alternatively, if either the content or size is not acceptable, the BS rejects the UECapabilityInformation and sends an RRCRelease message with a releaseCause field set to either AS-capability-check-fail (if the content is unacceptable) or AS-capability-size-full (if the size exceeds the network's memory limitation represented by the field maxSizeforUCI). This message flow ensures that the UE is informed of any capability-related issues and can take appropriate corrective actions.

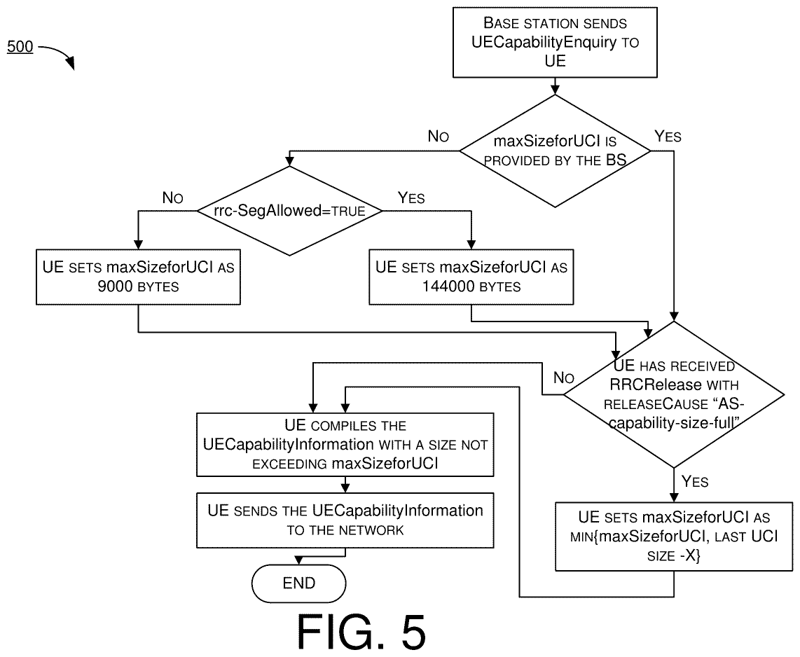

FIG. 5 illustrates an example process 500 for UE-side handling of UE capability information in accordance with an implementation of the present disclosure. Process 500 begins when the base station sends a UECapabilityEnquiry message to the UE. The UE first determines whether maxSizeforUCI is provided by the BS. If maxSizeforUCI is provided by the BS, the UE uses this value directly. If maxSizeforUCI is not provided, the UE checks whether rrc-SegAllowed equals TRUE, which indicates that uplink RRC message segmentation is supported. If segmentation is supported (rrc-SegAllowed=TRUE), the UE sets maxSizeforUCI to 144000 bytes, representing 16 times the maximum PDCP SDU size of 9000 bytes. If segmentation is not supported (rrc-segallowed≠true), the ue sets maxsizeforuci to 9000 bytes, representing the maximum PDCP SDU size. Additionally, the UE checks whether it has previously received an RRCRelease message with releaseCause set to “AS-capability-size-full.” If such a release was previously received, the UE sets maxSizeforUCI to the minimum value between the current maxSizeforUCI and the size of the last transmitted UECapabilityInformation message minus X bytes, where X is a value configured by the UE to progressively reduce the message size. UE capability information message that the UE transmitted to the network node immediately before receiving an RRCRelease message with releaseCause set to “AS-capability-size-full.” After determining the appropriate maxSizeforUCI value, the UE compiles the UECapabilityInformation message with a size not exceeding maxSizeforUCI. The UE then sends the UECapabilityInformation message to the network (e.g., BS 121 and the AMF), and the process ends. This process ensures that the UE capability information message complies with network memory limitations and progressively adapts to network constraints based on previous connection release events.

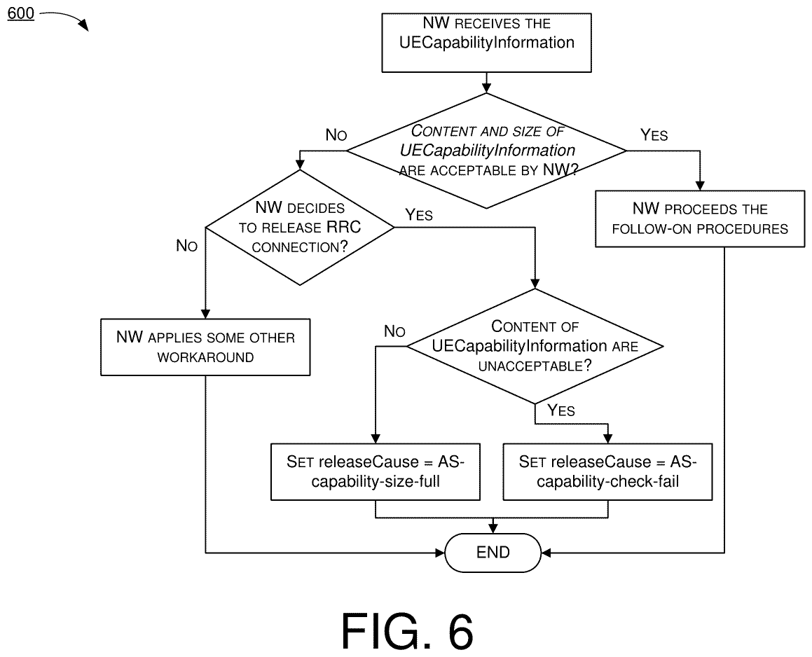

FIG. 6 illustrates an example process 600 for network-side handling of UE capability information in accordance with an implementation of the present disclosure. Process 600 begins when the network (NW) (e.g., BS 121 and the AMF) receives the UECapabilityInformation message from the UE (e.g., UE 110). The network (e.g., BS 121 and/or the AMF) first determines whether both the content and size of the UECapabilityInformation are acceptable. If both the content and size are acceptable, the network proceeds with the follow-on procedures, which may include configuring carrier aggregation, dual connectivity, or other advanced features based on the reported UE capabilities. If the content and/or size are not acceptable, the network determines whether to release the RRC connection or apply some other workaround. If the network decides not to release the RRC connection, it applies some other workaround to handle the unacceptable capability information. If the network decides to release the RRC connection, it further determines which aspect of the UECapabilityInformation is unacceptable.

If the content of the UECapabilityInformation is unacceptable (e.g., the network cannot recognize certain capability information elements or the reported capabilities are incompatible with network requirements), the network sets releaseCause to AS-capability-check-fail.

If the size of the UECapabilityInformation exceeds the network's memory limitation (but the content itself would be acceptable), the network sets releaseCause to AS-capability-size-full.

After setting the appropriate releaseCause value, the network sends an RRCRelease message with the releaseCause value to the UE, and the process ends. By providing this explicit cause information, the network enables the UE to take appropriate corrective actions, such as disabling or downgrading UE capability, reducing UE capability message size, or attempting cell reselection to find an alternative network that may have different capability requirements or greater storage capacity, thereby preventing repeated unsuccessful connection attempts to the same cell and improving overall network efficiency. This process allows the network to provide specific feedback to the UE regarding why the capability information was not acceptable, enabling the UE to take appropriate corrective actions.

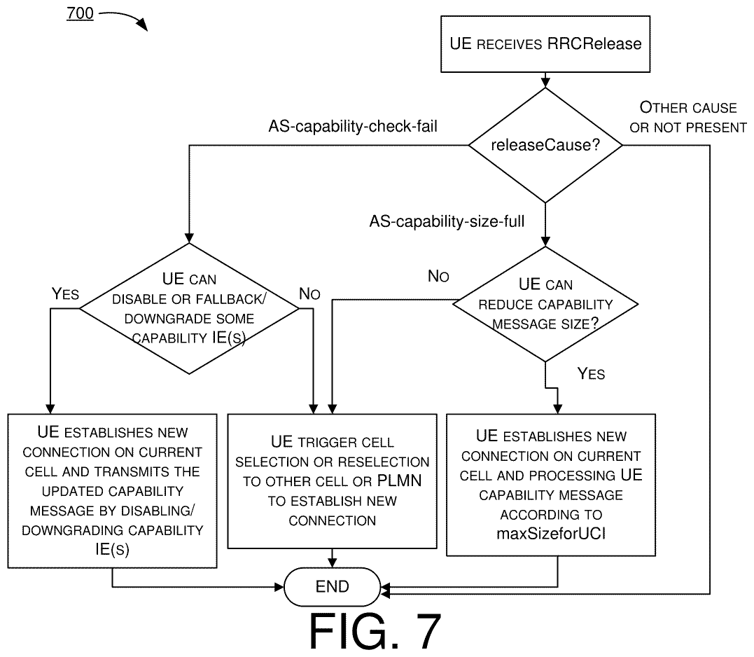

FIG. 7 illustrates an example process 700 for UE-side response to RRC release in accordance with an implementation of the present disclosure. Process 700 begins when the UE receives an RRCRelease message from the network (e.g., the RRCRelease message with the releaseCause value). The UE examines the releaseCause field in the RRCRelease message to determine the appropriate response.

If the releaseCause is AS-capability-check-fail, indicating that the network does not accept the content of the UE capability information, the UE determines whether it can disable or fallback/downgrade some capability information elements (IEs). If the UE can disable or fallback/downgrade some capability IEs, the UE establishes a new connection on the current cell and transmits an updated capability message with the modified content, specifically by disabling certain capability IEs introduced in newer releases or by falling back or downgrading the values of certain capability IEs to levels or releases that the network can accept. If the UE cannot disable or fallback/downgrade capability IEs, the UE triggers cell selection or reselection to another cell or PLMN to establish a new connection with a different network that may accept the UE's capabilities.

If the releaseCause is AS-capability-size-full, indicating that the size of the UE capability information message exceeds the network's memory limitation, the UE determines whether it can reduce the capability message size. If the UE can reduce the capability message size, the UE establishes a new connection on the current cell and processes the UE capability message according to maxSizeforUCI as described in FIG. 5, which includes setting maxSizeforUCI to the minimum of the current maxSizeforUCI and the last UE capability information message size minus X bytes. The last UE capability information message is the UECapabilityInformation message that was sent by the UE in the most recent capability transfer procedure that resulted in the network releasing the RRC connection due to size limitations. The size of this message serves as a reference point for the UE to calculate a reduced maxSizeforUCI value for the next connection attempt. The calculation is illustrated as:

maxSizeforUCI=min{current maxSizeforUCI, (size of last transmitted UECapabilityInformation)−X bytes}

By referencing the last transmitted message size, the UE can progressively reduce the size of subsequent UECapabilityInformation messages to avoid repeated connection failures due to exceeding the network's memory limitations.

If the UE cannot reduce the capability message size further, the UE triggers cell selection or reselection to another cell or PLMN to establish a new connection. If the releaseCause is set to some other cause or is not present, the UE handles the release according to normal RRC connection release procedures. After completing the appropriate action, the process ends. This process enables the UE to intelligently respond to capability-related connection releases by either modifying the capability information to meet network requirements or seeking alternative network connections that can accommodate the UE's capabilities.

### Illustrative Implementations

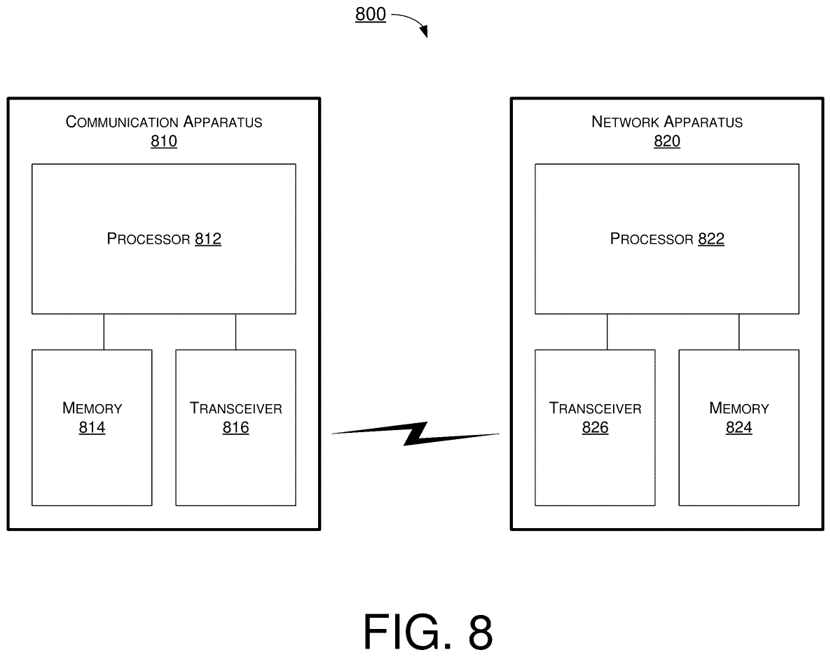

FIG. 8 illustrates an example communication system 800 having an example communication apparatus 810 and an example network apparatus 820 in accordance with an implementation of the present disclosure. Each of communication apparatus 810 and network apparatus 820 may perform various functions to implement schemes, techniques, processes and methods described herein pertaining to processing UE capability information in mobile communications, including scenarios/schemes described above as well as process 900 and process 1000 described below.

Communication apparatus 810 may be a part of an electronic apparatus, which may be a UE such as a portable or mobile apparatus, a wearable apparatus, a wireless communication apparatus, or a computing apparatus. For instance, communication apparatus 810 may be implemented in a smartphone, a smartwatch, a personal digital assistant, a digital camera, or a computing equipment such as a tablet computer, a laptop computer, or a notebook computer. Communication apparatus 810 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 810 may be implemented in a smart thermostat, a smart fridge, a smart door lock, a wireless speaker or a home control center. Alternatively, communication apparatus 810 may be implemented in the form of one or more integrated-circuit (IC) chips, such as, for example and without limitation, one or more single-core processors, one or more multi-core processors, one or more reduced-instruction set computing (RISC) processors, or one or more complex-instruction-set-computing (CISC) processors. Communication apparatus 810 may include at least some of those components shown in FIG. 8, such as a processor 812, for example. Communication apparatus 810 may further include one or more other components not pertinent to the proposed scheme of the present disclosure (e.g., internal power supply, display device and/or user interface device), and, thus, such component(s) of communication apparatus 810 are neither shown in FIG. 8 nor described below in the interest of simplicity and brevity.

Network apparatus 820 may be a part of a network apparatus, which may be a network node such as a satellite, a base station, a small cell, a router, a gateway, or other network element. For instance, network apparatus 820 may be implemented in an eNodeB in an LTE network, in a gNB in a 5G/NR, IoT, NB-IoT or IIoT network or in a satellite or base station in a 6G network. Alternatively, network apparatus 820 may be implemented in the form of one or more IC chips such as, for example and without limitation, one or more single-core processors, one or more multi-core processors, or one or more RISC or CISC processors. Network apparatus 820 may include at least some of those components shown in FIG. 8 such as a processor 822, for example. Network apparatus 820 may further include one or more other components not pertinent to the proposed scheme of the present disclosure (e.g., internal power supply, display device and/or user interface device), and, thus, such component(s) of network apparatus 820 are neither shown in FIG. 8 nor described below in the interest of simplicity and brevity.

In one aspect, each of processor 812 and processor 822 may be implemented in the form of one or more single-core processors, one or more multi-core processors, or one or more CISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed, arranged and configured to perform specific tasks including processing UE capability information in accordance with various implementations of the present disclosure.

In some implementations, communication apparatus 810 may also include a transceiver 816 coupled to processor 812 and capable of wirelessly transmitting and receiving data. In some implementations, communication apparatus 810 may further include a memory 814 coupled to processor 812 and capable of being accessed by processor 812 and storing data therein. In some implementations, network apparatus 820 may also include a transceiver 826 coupled to processor 822 and capable of wirelessly transmitting and receiving data. In some implementations, network apparatus 820 may further include a memory 824 coupled to processor 822 and capable of being accessed by processor 822 and storing data therein. Accordingly, communication apparatus 810 and network apparatus 820 may wirelessly communicate with each other via transceiver 816 and transceiver 826, respectively.

To aid better understanding, the following description of the operations, functionalities and capabilities of each of communication apparatus 810 and network apparatus 820 is provided in the context of a mobile communication environment in which communication apparatus 810 is implemented in or as a communication apparatus or a UE and network apparatus 820 is implemented in or as a network node of a communication network.

### Illustrative Processes

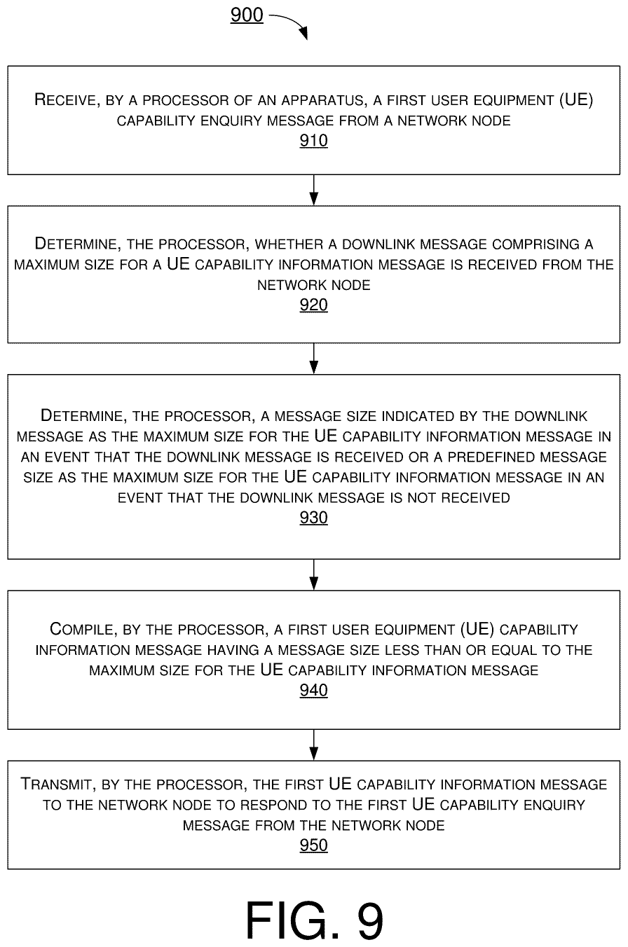

FIG. 9 illustrates an example process 900 in accordance with an implementation of the present disclosure. Process 900 may be an example implementation of above scenarios/schemes, whether partially or completely, with respect to processing UE capability information of the present disclosure. Process 900 may represent an aspect of implementation of features of communication apparatus 810. Process 900 may include one or more operations, actions, or functions as illustrated by one or more of blocks 910 to 950. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by communication apparatus 810 or any suitable UE or machine type devices. Solely for illustrative purposes and without limitation, process 900 is described below in the context of communication apparatus 810. Process 900 may begin at block 910.

At block 910, process 900 may involve processor 812 of communication apparatus 810 receiving, via transceiver 816, a first user equipment (UE) capability enquiry message from a network node (e.g., network apparatus 820). Process 900 may proceed from block 910 to block 920.

At block 920, process 900 may involve processor 812 of communication apparatus 810 determining whether a downlink message comprising a maximum size for a UE capability information message (e.g., maxSizeforUCI) is received from the network node (e.g., network apparatus 820). Process 900 may proceed from block 920 to block 930.

At block 930, process 900 may involve processor 812 of communication apparatus 810 determining a message size indicated by the downlink message as the maximum size for the UE capability information message in an event that the downlink message is received or a predefined message size as the maximum size for the UE capability information message in an event that the downlink message is not received. Process 900 may proceed from block 930 to block 940.

At block 940, process 900 may involve processor 812 of communication apparatus 810 compiling a first UE capability information message having a message size less than or equal to the maximum size for the UE capability information message. Process 900 may proceed from block 940 to block 950.

At block 950, process 900 may involve processor 812 of communication apparatus 810 transmitting, via transceiver 816, the first UE capability information message to the network node to respond to the first UE capability enquiry message from the network node.

In some implementations, process 900 may further involve processor 812 of communication apparatus 810 receiving, via transceiver 816, a radio resource control (RRC) release message with a first release cause (e.g., “AS-capability-check-fail”) from the network node. Furthermore, process 900 may involve processor 812 of communication apparatus 810 performing at least one of: disabling at least one UE capability information element (IE); falling back a value of at least one UE capability IE in a second UE capability information message; or downgrading a value of at least one UE capability IE in the second UE capability information message. Furthermore, process 900 may involve processor 812 of communication apparatus 810 transmitting, via transceiver 816, the second UE capability information message to the network node to respond to a second UE capability enquiry message from the network node.

In some implementations, the first release cause indicates a UE capability check failure caused by content of the first UE capability information message.

In some implementations, process 900 may involve processor 812 of communication apparatus 810 receiving, via transceiver 816, a radio resource control (RRC) release message with a first release cause from the network node. Furthermore, process 900 may involve processor 812 of communication apparatus 810 initiating a cell selection or a cell reselection for establishing a connection to another cell.

In some implementations, process 900 may involve processor 812 of communication apparatus 810 receiving, via transceiver 816, a radio resource control (RRC) release message with a second release cause (e.g., “AS-capability-size-full”) from the network node. Furthermore, process 900 may involve processor 812 of communication apparatus 810 reducing a size of a third UE capability information message. Furthermore, process 900 may involve processor 812 of communication apparatus 810 transmitting, via transceiver 816, the third UE capability information message to the network node to respond to a third UE capability enquiry message from the network node.

In some implementations, the second release cause indicates that an RRC release is caused by the message size of the first UE capability information message exceeding the message size indicated by the downlink message.

In some implementations, process 900 may involve processor 812 of communication apparatus 810 receiving, via transceiver 816, a radio resource control (RRC) release message with a second release cause from the network node. Furthermore, process 900 may involve processor 812 of communication apparatus 810 initiating a cell selection or a cell reselection for establishing a connection to another cell.

In some implementations, the downlink message comprises one or a combination of a system information block (SIB) message and a radio resource control (RRC) message.

In some implementations, the RRC message comprises a user equipment (UE) capability enquiry message (e.g., “UECapabilityEnquiry-IE”) or a dedicated RRC message.

In some implementations, the maximum size for the UE capability information message is set to a first value in an event that uplink RRC message segmentation is supported. The maximum size for the UE capability information message is set to a second value in an event that uplink RRC message segmentation is not supported.

In some implementations, the maximum size for the UE capability information message is set to a maximum number of allowed segments times a maximum size of a Packet Data Convergence Protocol (PDCP) Service Data Unit (SDU) in an event that uplink RRC message segmentation is supported. The maximum size for the UE capability information message is set to the maximum size of a PDCP SDU in an event that uplink RRC message segmentation is not supported. For example, if segmentation is supported, the UE sets maxSizeforUCI to 144000 bytes (representing 16 times the maximum PDCP SDU size). For example, if segmentation is not supported, the UE sets maxSizeforUCI to 9000 bytes (representing the maximum PDCP SDU size).

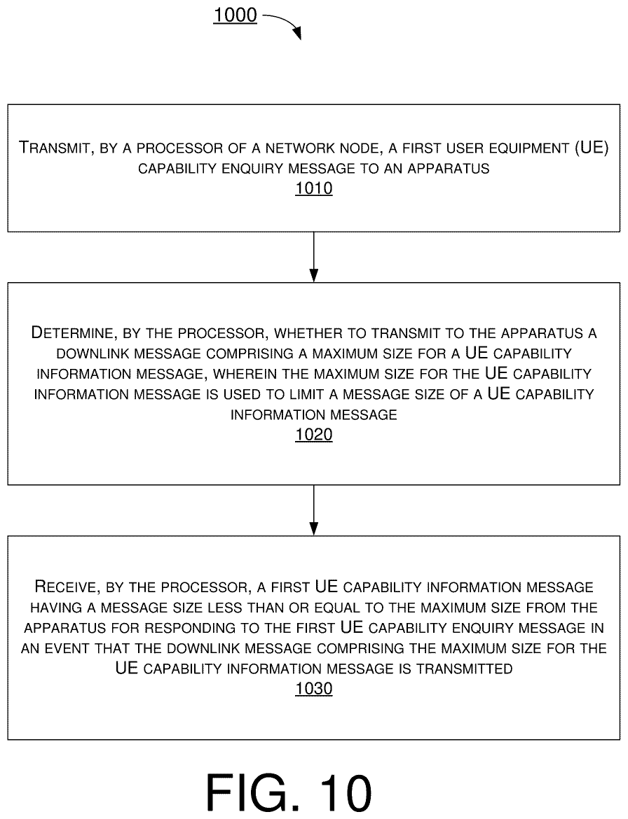

FIG. 10 illustrates an example process 1000 in accordance with an implementation of the present disclosure. Process 1000 may be an example implementation of above scenarios/schemes, whether partially or completely, with respect to processing UE capability information in mobile communications. Process 1000 may represent an aspect of implementation of features of network apparatus 820. Process 1000 may include one or more operations, actions, or functions as illustrated by one or more of blocks 1010 to 1030. Although illustrated as discrete blocks, various blocks of process 1000 may be divided into additional blocks, combined into fewer blocks, or eliminated, depending on the desired implementation. Moreover, the blocks of process 1000 may be executed in the order shown in FIG. 10 or, alternatively, in a different order. Process 1000 may be implemented by network apparatus 820 or any base stations or network nodes. Solely for illustrative purposes and without limitation, process 1000 is described below in the context of network apparatus 820. Process 1000 may begin at block 1010.

At block 1010, process 1000 may involve processor 822 of network apparatus 820 transmitting a first user equipment (UE) capability enquiry message to an apparatus (e.g., communication apparatus 810). Process 1000 may proceed from block 1010 to block 1020.

At block 1020, process 1000 may involve processor 822 of network apparatus 820 determining whether to transmit to the apparatus (e.g., communication apparatus 810) a downlink message comprising a maximum size for a UE capability information message (e.g., maxSizeforUCI). Specifically, the maximum size for the UE capability information message is used to limit a message size of a UE capability information message. Process 1000 may proceed from block 1020 to block 1030.

At block 1030, process 1000 may involve processor 822 of network apparatus 820 receiving, via transceiver 826, a first UE capability information message having a message size less than or equal to the maximum size from the apparatus for responding to the first UE capability enquiry message in an event that the downlink message comprising the maximum size for the UE capability information message is transmitted.

In some implementations, process 1000 may involve processor 822 of network apparatus 820 transmitting, via transceiver 826, a radio resource control (RRC) release message with a first release cause (e.g., “AS-capability-check-fail”) to the apparatus. Furthermore, process 1000 may involve processor 822 of network apparatus 820 receiving, via transceiver 826, a second UE capability information message in response to a second UE capability enquiry message that is transmitted after the RRC release message with the first release cause. Specifically, the second UE capability information message comprises at least one UE capability information element (IE) disabled or a value of at least one UE capability IE being fallen back or downgraded.

In some implementations, the first release cause indicates a UE capability check failure caused by content of the first UE capability information message.

In some implementations, process 1000 may involve processor 822 of network apparatus 820 transmitting, via transceiver 826, a radio resource control (RRC) release message with a second release cause (e.g., “AS-capability-size-full”) to the apparatus. Furthermore, process 1000 may involve processor 822 of network apparatus 820 receiving, via transceiver 826, a third UE capability information message with a reduced size in response to a third UE capability enquiry message that is transmitted, by processor 822 via transceiver 826, after the RRC release message with the second release cause.

In some implementations, the second release cause indicates that an RRC release is caused by the message size of the first UE capability information message exceeding a message size indicated by the downlink message.

In some implementations, the downlink message comprises one or a combination of a system information block (SIB) message and a radio resource control (RRC) message.

In some implementations, the RRC message comprises a user equipment (UE) capability enquiry message (e.g., “UECapabilityEnquiry-IE,”) or a dedicated RRC message.

In some implementations, the maximum size for the UE capability information message is set to a first value in an event that uplink RRC message segmentation is supported. The maximum size for the UE capability information message is set to a second value in an event that uplink RRC message segmentation is not supported.

In some implementations, the maximum size for the UE capability information message is set to a maximum number of allowed segments times a maximum size of a Packet Data Convergence Protocol (PDCP) Service Data Unit (SDU) in an event that uplink RRC message segmentation is supported. The maximum size for the UE capability information message is set to the maximum size of a PDCP SDU in an event that uplink RRC message segmentation is not supported.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a first user equipment (UE) capability enquiry message from a network node;
determining, by the processor, whether a downlink message comprising a maximum size for a UE capability information message is received from the network node;
determining, by the processor, a message size indicated by the downlink message as the maximum size for the UE capability information message in an event that the downlink message is received or a predefined message size as the maximum size for the UE capability information message in an event that the downlink message is not received;
compiling, by the processor, a first UE capability information message having a message size less than or equal to the maximum size for the UE capability information message; and
transmitting, by the processor, the first UE capability information message to the network node to respond to the first UE capability enquiry message from the network node.

2. The method of claim 1, further comprising:
receiving, by the processor, a radio resource control (RRC) release message with a first release cause from the network node;
performing, by the processor, at least one of: disabling at least one UE capability information element (IE); falling back a value of at least one UE capability IE in a second UE capability information message; or downgrading a value of at least one UE capability IE in the second UE capability information message; and
transmitting, by the processor, the second UE capability information message to the network node to respond to a second UE capability enquiry message from the network node.

3. The method of claim 2, wherein the first release cause indicates a UE capability check failure caused by content of the first UE capability information message.

4. The method of claim 1, further comprising:
receiving, by the processor, a radio resource control (RRC) release message with a first release cause from the network node; and
initiating, by the processor, a cell selection or a cell reselection for establishing a connection to another cell.

5. The method of claim 1, further comprising:
receiving, by the processor, a radio resource control (RRC) release message with a second release cause from the network node;
reducing, by the processor, a size of a third UE capability information message; and
transmitting, by the processor, the third UE capability information message to the network node to respond to a third UE capability enquiry message from the network node.

6. The method of claim 5, wherein the second release cause indicates that an RRC release is caused by the message size of the first UE capability information message exceeding the message size indicated by the downlink message.

7. The method of claim 1, further comprising:
receiving, by the processor, a radio resource control (RRC) release message with a second release cause from the network node; and
initiating, by the processor, a cell selection or a cell reselection for establishing a connection to another cell.

8. The method of claim 1, wherein the downlink message comprises one or a combination of a system information block (SIB) message and a radio resource control (RRC) message.

9. The method of claim 8, wherein the RRC message comprises a user equipment (UE) capability enquiry message or a dedicated RRC message.

10. The method of claim 1, wherein the maximum size for the UE capability information message is set to a first value in an event that uplink RRC message segmentation is supported, and wherein the maximum size for the UE capability information message is set to a second value in an event that uplink RRC message segmentation is not supported.

11. The method of claim 10, wherein the maximum size for the UE capability information message is set to a maximum number of allowed segments times a maximum size of a Packet Data Convergence Protocol (PDCP) Service Data Unit (SDU) in an event that uplink RRC message segmentation is supported, and wherein the maximum size for the UE capability information message is set to the maximum size of a PDCP SDU in an event that uplink RRC message segmentation is not supported.

12. A method, comprising:
transmitting, by a processor of a network node, a first user equipment (UE) capability enquiry message to an apparatus;
determining, by the processor, whether to transmit to the apparatus a downlink message comprising a maximum size for a UE capability information message, wherein the maximum size for the UE capability information message is used to limit a message size of a UE capability information message; and
receiving, by the processor, a first UE capability information message having a message size less than or equal to the maximum size from the apparatus for responding to the first UE capability enquiry message in an event that the downlink message comprising the maximum size for the UE capability information message is transmitted.

13. The method of claim 12, further comprising:
transmitting, by the processor, a radio resource control (RRC) release message with a first release cause to the apparatus; and
receiving, by the processor, a second UE capability information message in response to a second UE capability enquiry message that is transmitted after the RRC release message with the first release cause, wherein the second UE capability information message comprises at least one UE capability information element (IE) disabled or a value of at least one UE capability IE being fallen back or downgraded.

14. The method of claim 12, wherein the first release cause indicates a UE capability check failure caused by content of the first UE capability information message.

15. The method of claim 12, further comprising:
transmitting, by the processor, a radio resource control (RRC) release message with a second release cause to the apparatus; and
receiving, by the processor, a third UE capability information message with a reduced size in response to a third UE capability enquiry message that is transmitted, by the processor, after the RRC release message with the second release cause.

16. The method of claim 15, wherein the second release cause indicates that an RRC release is caused by the message size of the first UE capability information message exceeding a message size indicated by the downlink message.

17. The method of claim 12, the downlink message comprises one or a combination of a system information block (SIB) message and a radio resource control (RRC) message.

18. The method of claim 17, wherein the RRC message comprises a user equipment (UE) capability enquiry message or a dedicated RRC message.

19. An apparatus, comprising:
a transceiver which, during operation, communicates wirelessly; and
a processor communicatively coupled to the transceiver such that, during operation, the processor performs operations comprising:
receiving, via the transceiver, a first user equipment (UE) capability enquiry message from a network node;
determining whether a downlink message comprising a maximum size for a UE capability information message is received from the network node;
determining a message size indicated by the downlink message as the maximum size for the UE capability information message in an event that the downlink message is received or a predefined message size as the maximum size for the UE capability information message in an event that the downlink message is not received;
compiling a first UE capability information message having a message size less than or equal to the maximum size for the UE capability information message; and
transmitting, via the transceiver, the first UE capability information message to the network node to respond to the first UE capability enquiry message from the network node.

20. The apparatus of claim 19, wherein the processor further performs operations comprising:
receiving, via the transceiver, a radio resource control (RRC) release message with a first release cause from the network node;
performing at least one of: disabling at least one UE capability information element (IE); falling back a value of at least one UE capability IE in a second UE capability information message; or downgrading a value of at least one UE capability IE in the second UE capability information message; and
transmitting, via the transceiver, the second UE capability information message to the network node to respond to a second UE capability enquiry message from the network node.
